(19) United States
(12) Patent Application Publication
(10) Pub. No.: US 2014/0023848 A1
(43) Pub. Date: Jan. 23, 2014

(54) Method For Making A Biodegradable And Compostable Component For Cosmetic Packaging

(71) Applicants: Agostinho Martins, New Hyde Park, NY (US); Eliot Drangeid McGuire, Penns Park, PA (US)

(72) Inventors: Agostinho Martins, New Hyde Park, NY (US); Eliot Drangeid McGuire, Penns Park, PA (US)

(21) Appl. No.: 13/554,195

(22) Filed: Jul. 20, 2012

(51) Int. Cl. B29C 43/20; A45D 33/00

(52) U.S. Cl. CPC B29C 43/203; A45D 33/00
USPC 428/292.1; 264/257

(57) ABSTRACT

A cosmetic product insert for a package for storing and dispensing a cosmetic product or a beauty care product including a biodegradable support component made from compressed fibrous biomass bound by a cosmetically compatible and compostable binder.

### BACKGROUND OF THE INVENTION

1. Field of the Invention

The present invention relates to cosmetic and personal care packaging. In particular, the present invention is directed to a cosmetic product insert with a biodegradable support component made from fibrous biomass and a cosmetically compatible and compostable binder, and methods for making and filling such packaging.

2. Description of the Prior Art

Most cosmetic and personal care packaging is currently made from non-biodegradable plastics, or from metal. Packaging made from non-biodegradable plastics has the problem of increasing waste stream. Packaging made from metal components often requires additional processing steps (e.g., grinding edges, removing burrs, cleaning, anti-corrosion treatment, surface polishing or roughening). In addition, metal parts may have sharp edges, or splinters or shavings associated with their production and use that could pose a hazard to consumers. To avoid the additional processing and safety concerns associated with metal parts, and to reduce waste flow and reduce negative impact on the environment associated with non-biodegradable plastic parts, there is a need for biodegradable cosmetic and personal care packaging, and in particular, a need for compostable packaging.

### BRIEF SUMMARY OF THE INVENTION

It is an object of the present invention to provide cosmetic and personal care packaging that includes biodegradable, compostable components, and methods for making and filling those components. The components are made from fibrous biomass held together with a compostable binder.

It is an object of the invention to provide a biodegradable component for a package for storing and dispensing a cosmetic product or a beauty care product, the component made from a compressed fibrous biomass bound by a cosmetically compatible and compostable binder, the component adapted to store, dispense or apply the product. The component has at least one surface adapted to contact the cosmetic or beauty care product. The at least one surface preferably has increased adhesion to the product. The increased adhesion is provided by at least one of free portions of biomass fibers extending from the surface, or rough topography of the surface, as described in greater detail herein. The surface can be further adapted for contact with a cosmetic or beauty care product by structure including at least one of lugs, recesses, patterning, dimpling, grooving, embossing and knurling.

It is an object of the invention to provide a method of making a biodegradable component for a package for storing and dispensing a cosmetic or beauty care product, the method comprising the steps of providing a mold cavity defined by a bottom wall and a side wall, and a corresponding die, the cavity and die when fully closed being dimensioned to form the component in a preselected and desired shape. A quantity of fibrous biomass sufficient to form the component is placed in the mold cavity. The quantity of fibrous biomass includes a cosmetically compatible and compostable biomass binder. The die is closed on the mold cavity under pressure to compress and bind the quantity of fibrous biomass such that the resin is cured and the component is formed. The die is opened from the mold cavity and the formed component is released. The biomass binder may be in whole or part a resin selected from the group consisting of a biodegradable one of polyurethane resin, polyester, aliphatitic polyester, polyvinyl alcohol, polycaprolactone, polyhydroxyalkanoate, denatured starch, a natural polymer, a polyisocyanate, polyglycolic acid, polylactic acid, polyhydroxybutyric acid, polyhydroxyvaleric acid, a polyhydroxycarboxylic acids, polybutylene succinate and polybutylene adipatea, or any other suitable binder that is compostable and cosmetically compatible. Alternatively, the compostable binder may be in whole or part a naturally occurring constituent of the fibrous biomass.

It is a further object of the invention to provide a method of filling a biodegradable component for a package for storing and dispensing cosmetic and beauty care products, the biodegradable component made from a fibrous biomass and a cosmetically compatible and compostable binder. The method includes the steps of forming the component to include a product reservoir such that at least one portion of a surface of the product reservoir has at least one of a rough surface topography or extending free portions of individual ones of the fibrous biomass. Once the component is formed, a quantity of product in a filling state is prepared, the quantity of product including a product binder. The quantity of product is filled into the reservoir such that it adheres mechanically to the surface when the product binder is cured or the product is pressed into the component.

It is a further object of the invention to provide a biodegradable component for a package for storing and dispensing cosmetic and beauty care products that is formed in a mold having a sidewall draft angle that is about 0 degrees to about 30 degrees.

It is a further object of the invention to provide a biodegradable component for a package for storing and dispensing cosmetic and beauty care products with a solid body made of compressed fibrous biomass and a cosmetically compatible and compostable binder, the body having a cavity for storing and dispensing a cosmetic product, wherein at least one surface in the cavity is adapted to contact and have increased adhesion to the product. The cavity is made by mechanical working of the solid body. The mechanical working is at least one of boring, milling, cutting, laser cutting, stamping, die cutting or grinding.

It is a further object of the invention to provide a method of making a biodegradable component for a package for storing and dispensing cosmetic products, wherein a solid body is made of compressed fibrous biomass including a cosmetically compatible and compostable binder and the body is mechanically worked to achieve a desired component shape and dimension. At least one surface in the component is adapted to contact and have increased adhesion to the product. The solid body is mechanically worked by at least one of boring, milling, cutting, laser cutting, stamping, die cutting or grinding.

It is a further object of the invention to provide a method for forming a cosmetic product insert for a cosmetic compact, the insert having product in the form of a dispensable supply portion secured to a support portion. The method comprises the steps of: providing a mold cavity defined by a bottom wall and a side wall, and a corresponding die, the cavity and die when fully closed being dimensioned to form the insert in a preselected and desired shape; providing a quantity of cosmetic product in a form suitable for placing in the cavity, the quantity of cosmetic product sufficient to form the dispensable supply portion; providing a quantity of fibrous biomass sufficient to form the support portion for the dispensable supply portion of cosmetic product; placing in the cavity a first layer selected from one of the quantity of cosmetic product and the quantity of fibrous biomass; placing in the cavity a second layer selected from the other of the quantity of cosmetic product and the quantity of fibrous biomass; and closing the die onto the mold cavity under pressure to compress the second layer and the first layer, and to adhere the second layer to the first layer such that the insert is formed. The cosmetic product includes a suitable cosmetically compatible cosmetic product binder. The quantity of fibrous biomass further comprises a cosmetically compatible and compostable biomass binder. The biomass binder and the cosmetic product binder are the same binder, or the biomass binder and the cosmetic product binder are different binders. The biomass binder may be in whole or part a resin selected from the group consisting of a biodegradable one of polyurethane resin, polyester, aliphatitic polyester, polyvinyl alcohol, polycaprolactone, polyhydroxyalkanoate, denatured starch, a natural polymer, a polyisocyanate, polyglycolic acid, polylactic acid, polyhydroxybutyric acid, polyhydroxyvaleric acid, a polyhydroxycarboxylic acids, polybutylene succinate, polybutylene adipatea, or any other suitable binder that is compostable and cosmetically compatible. Alternatively, the biomass binder may be in whole or part a naturally occurring constituent of the fibrous biomass.

### BRIEF DESCRIPTION OF THE DRAWINGS

FIG. 1 is a cross-sectional side elevation of a compact wherein one or more components of the compact are biodegradable, compostable components made according to the invention.

FIG. 2 is a cross-sectional side elevation view of a mold and die that may be used in making the component of the invention, in an open position;

FIG. 3 is a cross-sectional side elevation view of the mold and die of FIG. 2 in a closed position

FIG. 4 is cross-sectional side elevation view of a component of the invention;

FIG. 5 is a cross-sectional side elevation view of a second embodiment of a mold and die that may be used in making the component of the invention, in an open position;

FIG. 6 is a cosmetic compact insert including a dispensable product supply portion and a biodegradable and compostable support portion for the supply portion;

FIG. 7 is a perspective view of pre-form solid board or block of fibrous biomass prior to mechanical working to shape the component;

FIG. 8 is a perspective view of the board or block shown in FIG. 7 after mechanical working to shape the component;

FIG. 9 is a cross-sectional side elevation view of the second embodiment of the biodegradable component according to the invention;

FIG. 10 is a cross-sectional side elevation view of the second embodiment of the biodegradable component according to the invention with a cover and product P;

FIG. 11 is a plan view close-up photograph of the surface of the present invention taken at 15× (15 times) magnification illustrating the rough surface topography and free portions of individual fibers of the fibrous biomass;

FIG. 12 is a plan view close-up photograph of the surface of the present invention taken at 35× (35 times) magnification illustrating the rough surface topography and free portions of individual fibers of the fibrous biomass;

FIG. 13 is a plan view close-up photograph of the surface of the present invention taken at 30× (30 times) magnification illustrating the rough surface topography and free portions of individual fibers of the fibrous biomass; and

FIG. 14 is a side elevation view close-up photograph of a sectional cut through the component of the present invention taken at 15∴ (15 times) magnification illustrating the rough surface topography and free portions of individual fibers of the fibrous biomass.

### DETAILED DESCRIPTION OF THE INVENTION

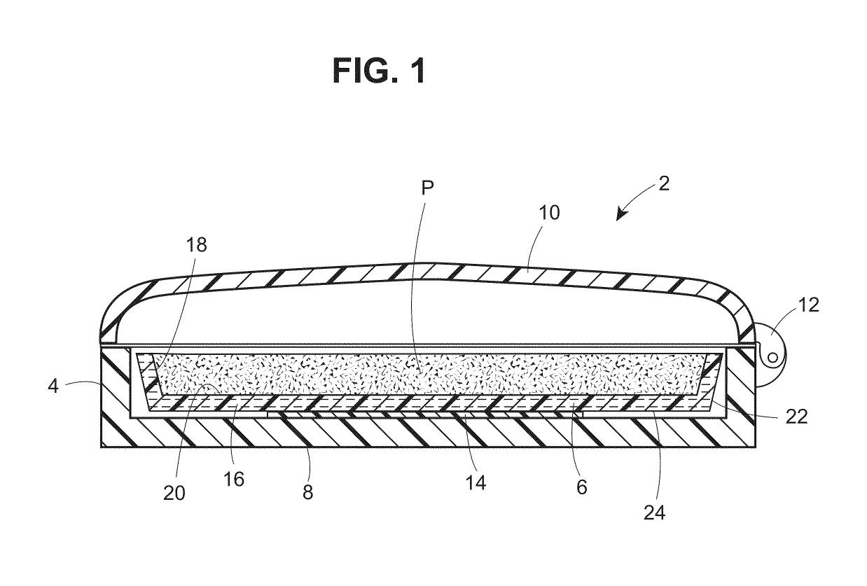

Referring now to FIG. 1, a package for storing and dispensing a cosmetic product or a beauty care product is shown generally at reference number 2. The package is in the form of a compact 4. The compact has a base 8, and a cover 10 (shown in the closed position) secured to the base 8 by a hinge 12. A biodegradable component 6 is provided in the form of a pan 16 with a side wall 22 and a bottom wall 24 defining a reservoir 18 for storing and dispensing the product P. The pan 16 is secured to the base 8 with an adhesive 14. The component 6 comprises a compressed fibrous biomass, also referred to as “biofiber”. The fibrous biomass is bound together by a cosmetically compatible and compostable binder. The component 6 is adapted to store, dispense or apply the product P.

At least one surface 20 of the component 6 is adapted to contact the product P and may be adapted to have increased adhesion to the product P. In the embodiment illustrated in FIG. 1, the surface 20 is an upper side of the bottom wall 24, but could alternatively be an inner side of sidewall 22, or both the upper side of bottom wall 24 and the inner side of sidewall 22.

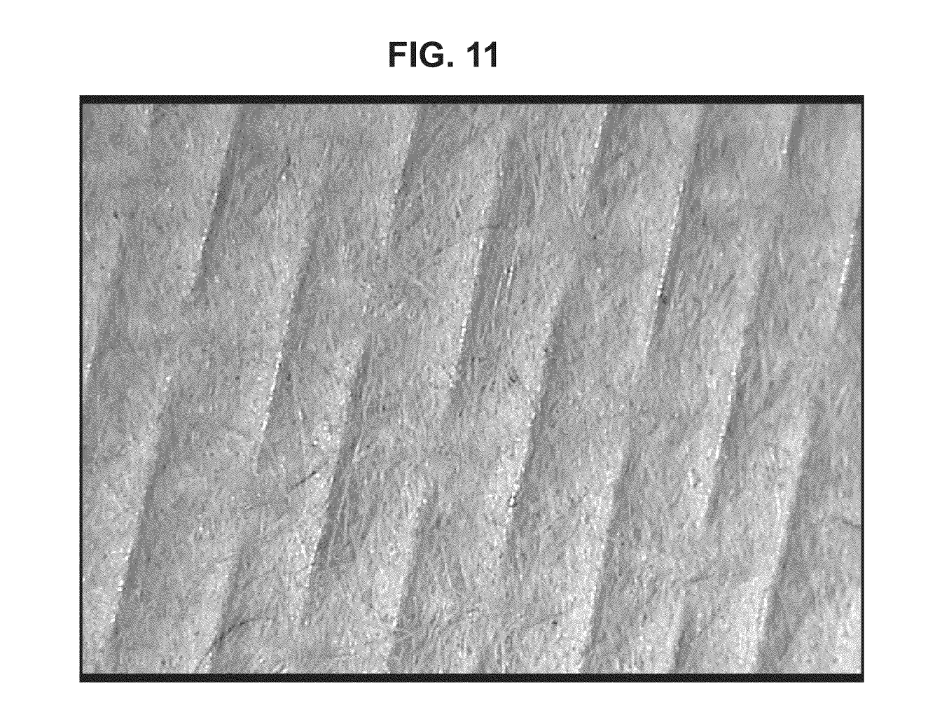

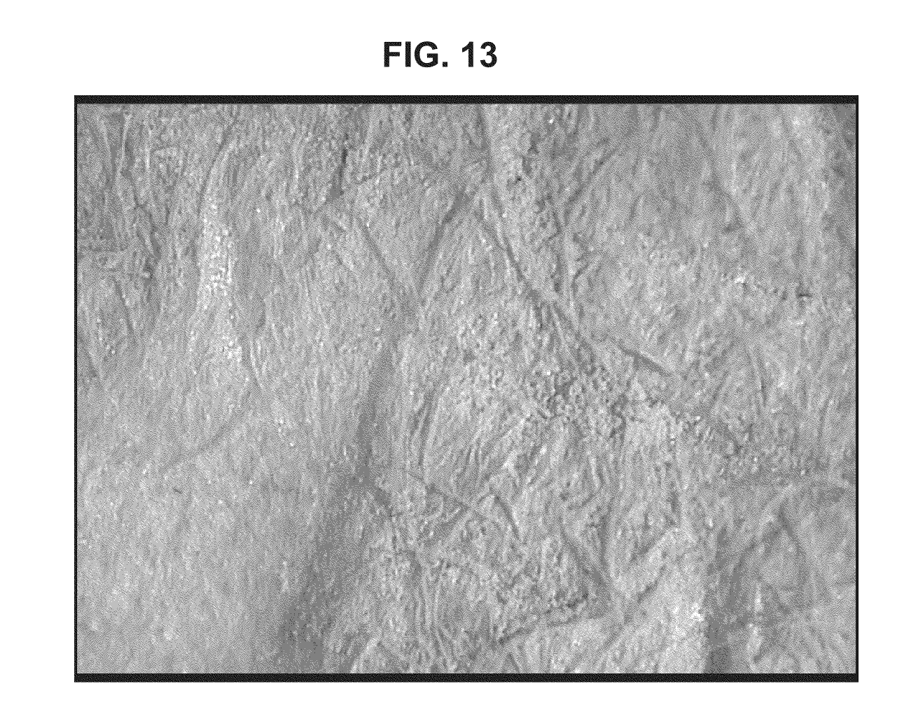

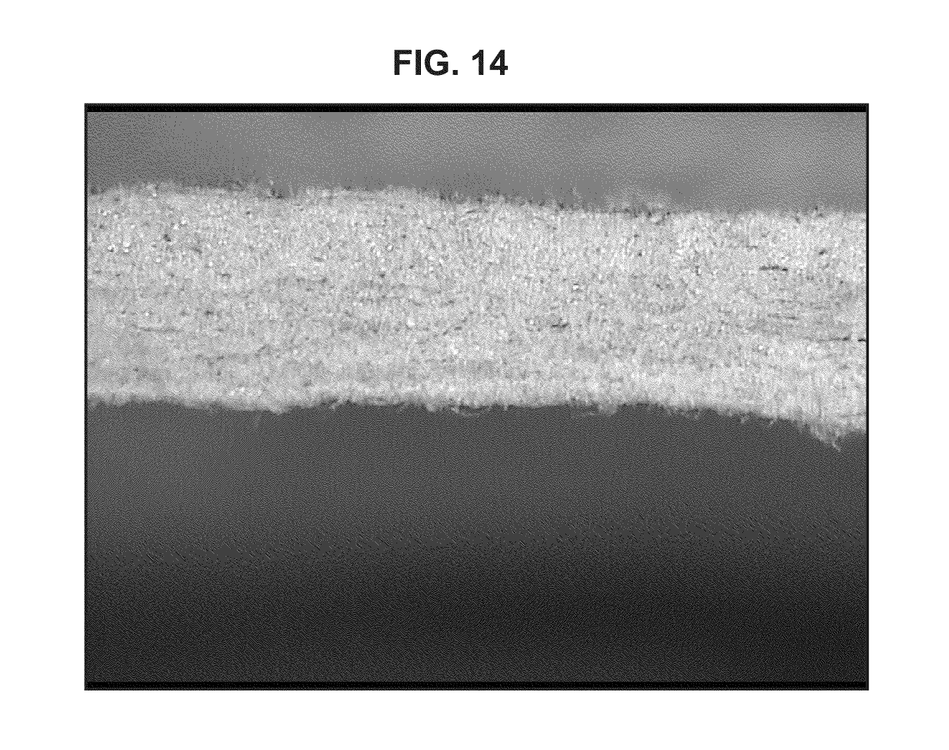

The surface 20 is adapted to have increased adhesion to the product P by way of a relatively rough surface topography caused by matted biomass fibers secured in a coarse binder surface with bumps, craters, recesses and pits (see FIGS. 11-13), and by random free portions of individual ones of the biomass fibers extending from the surface (see FIGS. 11-14). The matted biomass fibers may be secured at random angles as shown, or in an oriented fashion (not shown). For clarity, “free portions” are defined herein as any portion or part of an individual one of the biomass fibers that extends from or above the surface or binder. The free portions include free ends of biomass fibers extending from the surface, as well as mid-portions of biomass fibers that arch from and return to the surface, or mid-portions of biomass fibers that bridge or span clearances in the surface caused by the bumps, craters, recesses, pits and stacked fibers in the surface. The surface 20 is also adapted to have increased adhesion due to the rough topography of surface 20 caused by shapes of the fibers and stacking of the fibers of the biomass embedded in binder in the surface 20. While to human touch, the surface 20 of a biodegradable component 6 of the present invention feels smooth, when viewed under a magnification of 15× to 35× (15 times to 35 times magnification) the biodegradable component has a relatively rough surface topography. Under magnification, the surface 20 of the fibrous biomass in binder appears much like matted grass or straw crushed down and trapped in dry mud (see FIGS. 11-13), with random free portions extending from the surface (FIGS. 11-14), including free ends of individual ones of the fibrous biomass. The stacked, crushed and matted biomass fibers secured in binder form a rough surface topography that include curved free portions of the biomass fibers bulging from the surface, voids, pits, craters and clearances in the surface between and under fibers, crossed fibers, parallel fibers and even random free portions of fibers protruding from the surface. It is believed that this relatively rough topography of the surface and the free portions of biomass fibers extending from the surface contribute significantly to the increased capacity of the cosmetic product P to adhere to the biodegradable component 6, such as pan 16. The rough surface topography and extending free portions of biomass fibers clearly increase the surface area that cosmetic product can adhere to. The increased adhesion of the components to the cosmetic product allows, for example, a cosmetic or personal care powder product to be pressed with significantly less pressure into the component 6, e.g., pan 16, yet still have excellent adhesion to the component. This increased adhesion provides a significant advantage over, for example, metal or plastic components that often require, prior to filling, a scrubbing, sanding, scraping, etching or erosion operation to increase adhesion to a level that is adequate. However, the adequate level of adhesion achieved after processing metal or plastic components is still magnitudes below the significantly elevated levels of adhesion provided by the biodegradable components of the present invention. To compensate for lower adhesion levels, for example, with pressed powder filling, the metal or plastic components require significantly higher pressing pressures to ensure adhesion of the product to the component. However, the higher adhesion levels of the present invention permit lower pressure pressing. Lower pressure pressing is preferred due to advantages such as a lower cost of processing machinery and manufacture, less waste due to reduced damage to product or components at lower pressure and a ‘softer’ product for the consumer. Products pressed at lower pressures are more desirable to consumers because they dispense more readily with a more desirable feel and payout—applicator brushes, pads and sponges load more easily and more fully and the ‘feel’ to the consumer is softer.

It should be noted that unless steps are taken during manufacture of the biodegradable component 6, generally all surfaces of component 6 will have some degree of increased adhesion for the reasons given above—rough surface topography and free portions of fibers protruding from the surface. Steps can be taken to reduce or eliminate the rough surface topography and/or protruding free portions of biomass fibers for applications where increased adhesion of product is less desirable, such as certain liquid or lotion containers, lip gloss packages, etc. The steps that can be taken to reduce adhesion include treating or coating a surface with a cosmetically compatible, and preferably compostable, varnish, paint, lacquer, resin, film or other suitable surface coating. Alternatively, for surfaces of component 6 that do not require increased adhesion to the product P, e.g., outer surfaces of pan 16, the component may be veneered or clad with, for example, a foil or film. The foil or film is preferably made from a biodegradable and compostable material. As another alternative, the surfaces of the pan 16, or any biodegradable component 6, may be treated with a waterproofing liquid or solution applied to either the interior or exterior of the pan or component.

Similarly, the surface 20 may be treated to resist penetration or absorption of the product P or of ingredients of the product P. The surface may be treated with a cosmetically compatible, and preferably compostable, varnish, paint, laquer, resin, film or other suitable surface coating.

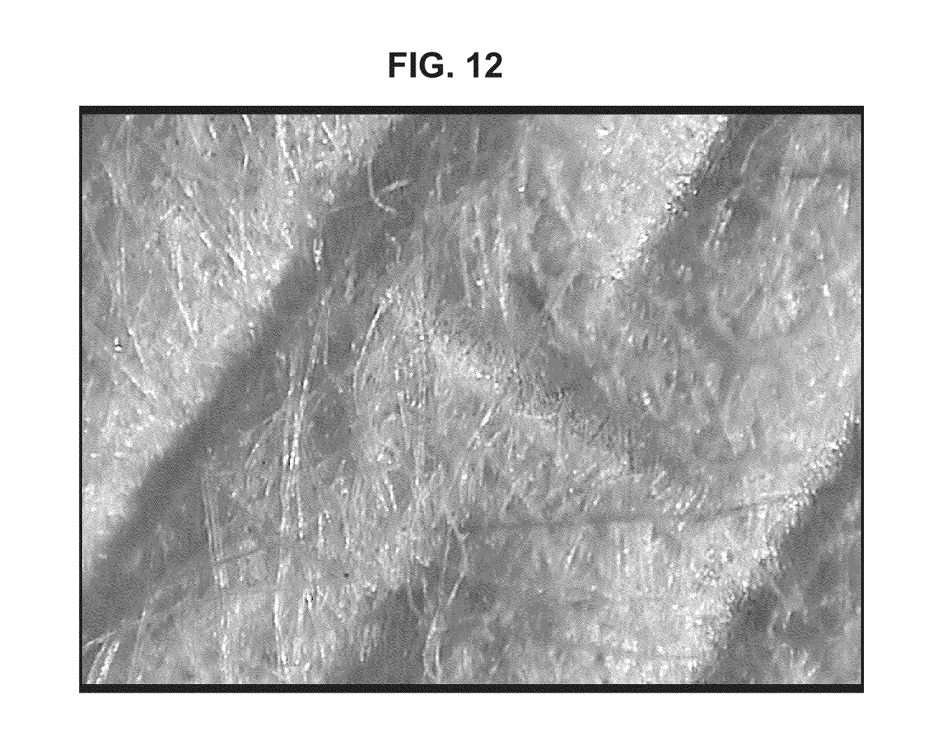

The surface 20 of the component 6 can be further adapted for adhesion by including structure on surface 20 such as lugs, recesses, patterning, dimpling, grooving, embossing, pillowing and knurling (see, for example, the pillowing in FIG. 11, or the grooves in FIG. 12). Providing such additional surface structure increases significantly (estimated to be by several magnitudes) the roughness of the biomass that protrudes slightly from the surface as well as the protruding free portions of biomass as the fibers are forced to bulge from the surface when the structures are formed by molding, stamping, cutting, grinding, etc.

In addition, the increased capacity for adhesion of the component 6 can be used to facilitate securing the component 6 to other parts of the package. For example, in the embodiment illustrated in FIG. 1, the bottom of the pan 16 is secured to the base 8 with adhesive 14. With the significantly increased adhesion capacity of the surfaces of biodegradable component 6, a manufacturer can use significantly less glue to secure the component 6 to the rest of the package 2.

Product P may be in the form of a pressed powder, a loose powder, a liquid, a stick, a rod, a bar, a puck, a gel, a cake, a paste, a lotion or pomade.

The fibrous biomass is preferably selected from one of wood pulp (e.g., hardwood such as, for example, maple, or softwood, such as, for example, pine or spruce, etc.), cellulose, bamboo, willow, bagasse (sugar cane pulp), corn, rice straw, reed, bulrush, coconut, agave, flax or palm. However, any biodegradable biological fiber will do. The fibrous biomass may constitute randomly or directionally non-woven mats, or woven mats of fibers. The mats may include chips of biomass material as well as strands of biomass material, either randomly positioned or oriented.

The cosmetically compatible and compostable binder may be in whole or part selected from a cosmetically compatible and biodegradable one of polyurethane resin, polyester, aliphatitic polyester, polyvinyl alcohol, polycaprolactone, polyhydroxyalkanoate, denatured starch, a natural polymer, a polyisocyanate, polyglycolic acid, polylactic acid, polyhydroxybutyric acid, polyhydroxyvaleric acid, a polyhydroxycarboxylic acids, polybutylene succinate and polybutylene adipatea (which can be obtained by polycondensation of polyhydric alcohols and polybasic acids), or any other suitable binder that is compostable and cosmetically compatible.

The cosmetically compatible and compostable binder may be in whole or part a naturally occurring constituent of the fibrous biomass that can be drawn out of the biomass and cured by processing, such as, for example, with heat or steam treatment and/or sufficient pressures. Alternatively, the fibrous biomass may be secured and solidified without binder simply by compression sufficient to cause friction-type adhesion between the fibers.

Although illustrated as a pan 16 in a compact 4, the biodegradable component 6 can be any part of a package, such as, for example, a cup (as in a lipstick or deodorant stick case), a cap, a lid, an applicator, a spatula, a dipper, a spoon, a rod, a bottle, a jar, a hinge, a pencil body or a frame. In the compact 4 illustrated in FIG. 1, the component 6 can also take the form of the base 8, lid 10 or hinge 12. For example, the hinge 12 could be made as a biodegradable component as a living hinge (not shown). A living hinge made of fibrous biomass and compostable resin could take advantage of the fibrous mat or woven nature of the material. In fact, biodegradable fibrous biomass components can be substituted for many of the components of cosmetic packaging currently made with plastic, glass or metal.

With respect to product P, solvents, cosmetic product binders (e.g., for pressed powder) or other ingredients included in product P should be selected to be minimally absorbed by component 6. If product P includes ingredients that are susceptible to absorption by the fibrous biomass or compostable binder of component 6, those ingredients should be provided in product P in sufficient quantity (a “threshold” quantity) to allow for such absorption without compromising the quality, purpose or effectiveness of product P. Ingredients of product P should also be selected to avoid or minimize expanding, discoloring or deforming the component 6. Alternatively, prior to bringing product P into contact with component 6, the contacting surface(s) can be treated as described in more detail above to minimize or eliminate undesired absorption, discoloration or deformation.

With pressed powder in particular, particle size of the powder can range from 100 nanometers to 200 microns.

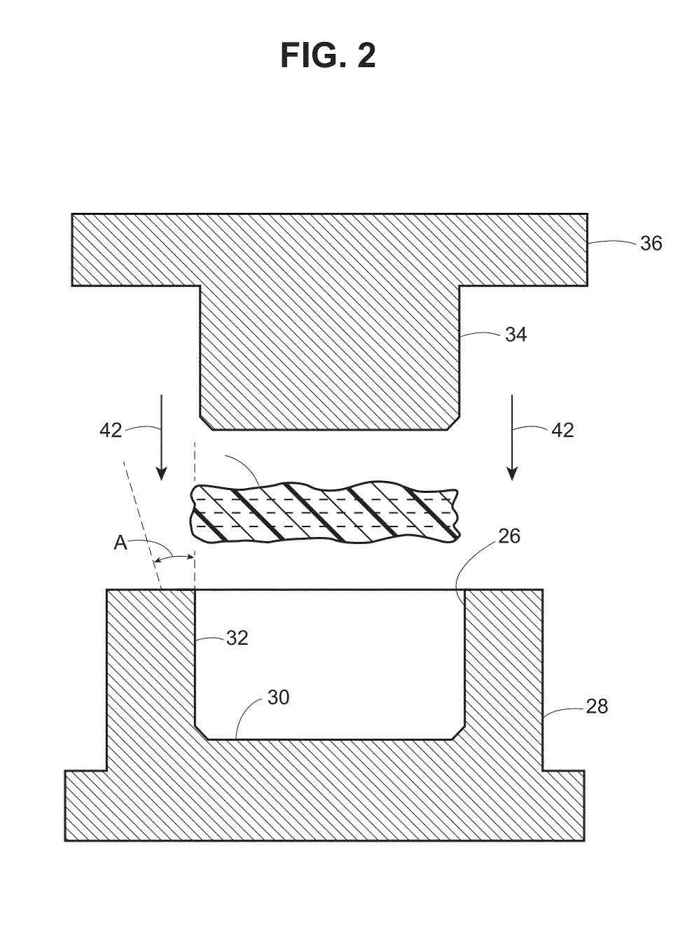

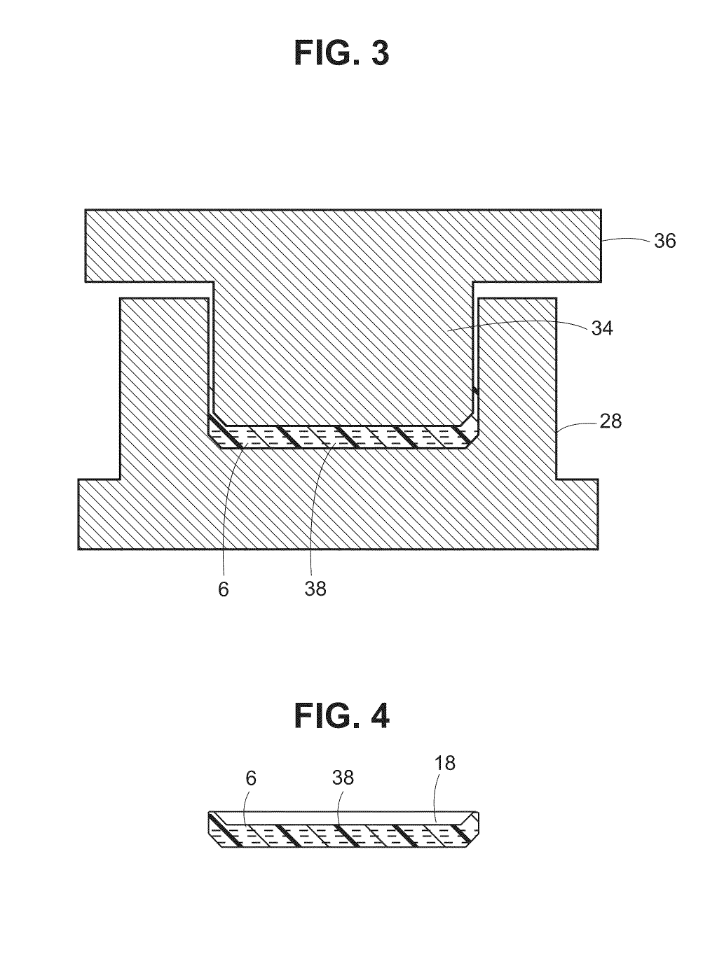

Referring now to FIGS. 2-4, the invention further comprises a method of making a biodegradable component 6 for a package 2 for storing and dispensing a cosmetic or beauty care product. The component 6 is a pan 38 (see FIG. 4) similar to pan 16 in the embodiment illustrated in FIG. 1. The method comprises a first step of providing a mold cavity 26 in a mold base 28. The mold cavity 26 has an upwardly directed opening and is defined by a bottom wall 30 and a side wall 32. A die 34 corresponding to the mold cavity depends from a top plate 36. The cavity 26 and die 34 when fully closed are dimensioned to form a clearance that defines the preselected and desired shape of the component 6, pan 38. A quantity 40 of fibrous biomass sufficient to form the component 6 is provided. The quantity 40 of fibrous biomass includes a cosmetically compatible and compostable biomass binder. The quantity 40 of fibrous biomass is placed in the cavity 26. The die 34 is lowered in the direction of arrows 42 to close the die onto the mold cavity to compress and bind the quantity of fibrous biomass under pressure such that the resin is cured and the component 6, pan 38, is formed. It will be understood that closing the die onto the mold cavity is done such that a pressure is applied to the quantity of fibrous biomass sufficient to compress and shape the quantity of fibrous biomass and cure the binder to form the component. The pressure applied to the molds and in turn to the biomass fiber may be in the range of 0.1 p.s.i. to 2,500 p.s.i. (“p.s.i.” is pounds per square inch) or higher. After compression and sufficient curing, the die is opened from the mold cavity to release the formed component 6, pan 38.

The cosmetically compatible and compostable biomass binder may be in whole or part a resin selected from a cosmetically compatible and biodegradable one of polyurethane resin, polyester, aliphatitic polyester, polyvinyl alcohol, polycaprolactone, polyhydroxyalkanoate, denatured starch, a natural polymer, a polyisocyanate, polyglycolic acid, polylactic acid, polyhydroxybutyric acid, polyhydroxyvaleric acid, a polyhydroxycarboxylic acids, polybutylene succinate or polybutylene adipatea, or any other suitable binder that is compostable and cosmetically compatible.

The cosmetically compatible and compostable biomass binder may alternatively or additionally be in whole or part a naturally occurring constituent of the fibrous biomass.

Steam or other forms of heat may be applied to the mold parts and/or the quantity of fibrous biomass prior to or during the step of closing the die onto the mold cavity under pressure. For example, the step of compressing the die onto the mold cavity may include heat or steam applied to one or more of the mold components, or through one or more of the mold components directly to the quantity of fibrous biomass in the mold cavity. The heat or steam is provided to help form and cure the component 6 by, for example, softening the fibers of the biomass or the cosmetically compatible and compostable binder, and/or to accelerate curing of the cosmetically compatible and compostable binder. The steam or other heat is applied, for example, in a quantity sufficient to soften the fibrous biomass and/or effect curing rate of the cosmetically compatible and compostable binder. For example, the steam may be provided to the mold cavity through channels, ports, vents or screens incorporated in the mold parts. Cooling fluids or gasses may also be provided to the mold parts or mold cavity to facilitate forming or curing activity in the mold.

The mold cavity and/or the die is configured to provide to the finished component at least one surface adapted to contact the cosmetic product P as described in greater detail above, and preferably adapted to have increased adhesion to the cosmetic product.

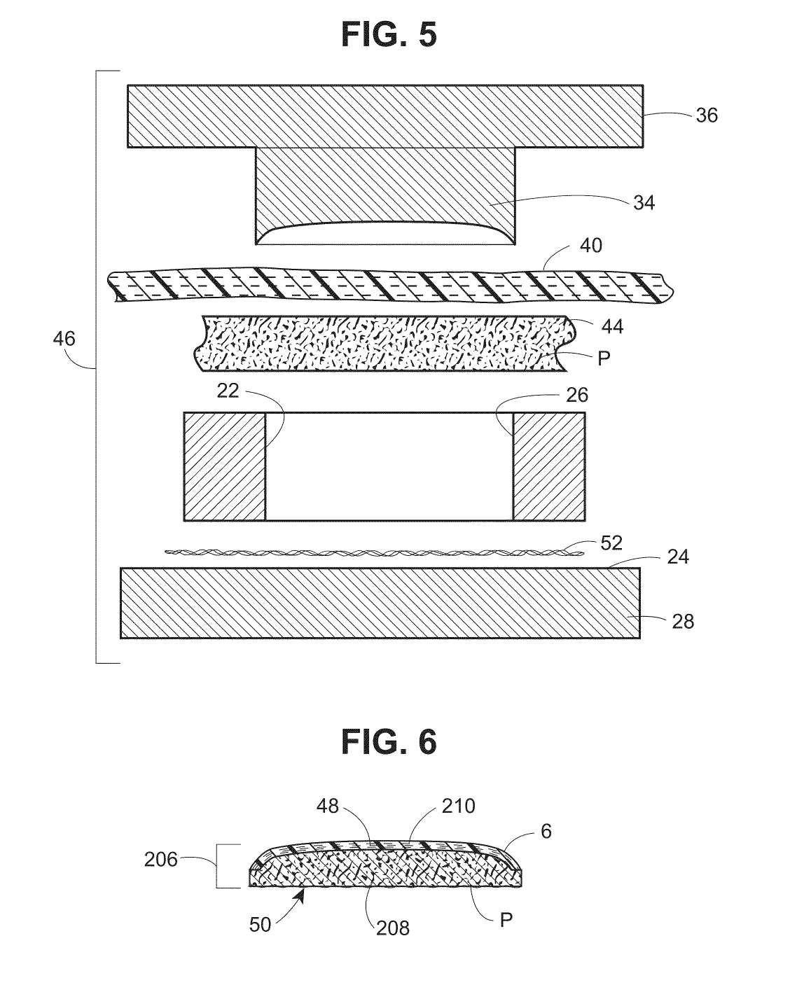

The mold 46 may also be provided in three parts as illustrated in FIG. 5. A die 34 depends from a top plate 36. A mold cavity 26 is defined by a circumferential sidewall 22. The mold cavity 26 is open at the top and bottom. A mold base 28 forms the bottom of the cavity when the mold components are closed. A quantity 40 of fibrous biomass is provided in a continuous sheet form. Product P is in a loosely packed cake 44, or may alternatively be provided as loose powder, liquid, paste or extrusion. A patterned sheet or screen 52 is provided above the base 28, but below the Product P. The patterned sheet or screen 52 is provided to emboss a pattern corresponding to that on the sheet or screen onto the product P when it is compressed in the mold. In the arrangement as illustrated in FIG. 5, the mold parts are closed to form in a single mold cycle the component 6 as a pan 48 (see FIG. 6) in an upside-down orientation and containing the packed product P. The pan 48 is illustrated in FIG. 6 in the upside down orientation as it would come out of the mold 46 upon release, with a pattern 50 in the surface of the product P. After release from the mold, the pan 48 containing product P can be righted and secured in a compact base 8 such as that shown in FIG. 1. It will be apparent to one of skill in the art that numerous other well known methods, mold types, mold arrangements, component orientations and sequences are possible to yield the desired results. For example, the component 6 may be made by pour molding or casting.

One method of filling a biodegradable component 6 for a package 2 for storing and dispensing cosmetic and beauty care products is to first fully or partially form the component 6. The component 6 is made from a fibrous biomass and a compostable binder as described above. The component 6 is formed to include a product reservoir 18 (see FIGS. 1, 4) such that at least one portion of a surface of the product reservoir has a rough surface topography and/or extending free portions of the fibrous biomass. A quantity 40 of product P is prepared in a fillable or filling state. Depending on the nature of the component, the product filling state may be a liquid, a paste, a fluid, a powder, a cake pre-form, a cake (final-form), an extrusion, a puck, etc. The quantity of product contains a product binder. The quantity of product in filling form is filled into the reservoir by, for example, inserting a cake, an extrusion or a puck, or pouring in a liquid, paste or slurry, etc. Alternatively, as described above and illustrated in FIGS. 5-6, the product P is formed in situ in the reservoir. Once the product P is in the reservoir 18, the product P is adhered to a surface 20 of the component 6 by curing the product binder and/or by pressing the product P into the rough topography of the surface 20 or causing the free fiber portions of the surface 20 to be trapped in the product P. Heating (e.g., steam) or cooling can be used to facilitate the curing process. Preferably, the pressing of product P into the reservoir, and/or the pressing of the fibrous biomass and product combination is conducted at pressures in the range of 0.1 p.s.i to 2,500 p.s.i.

The biodegradable component 6 for a package 2 for storing and dispensing cosmetic and beauty care products can be formed in a mold cavity having a sidewall draft angle A that is about 0 degrees to about 30 degrees (see FIG. 2). Preferably the mold cavity sidewall draft angle A is about 0.1 degree to about 17 degrees to facilitate release of the component 6 from the cavity. Most preferably, the mold cavity sidewall draft angle A is about 1 degree to about 7 degrees. The preferred mold cavity sidewall draft angles work particularly well where the component is a pressed powder pan, and where the pan is adapted to be used in a filling operation at powder pressing pressures in the range of 0.1 p.s.i to 2,500 p.s.i.

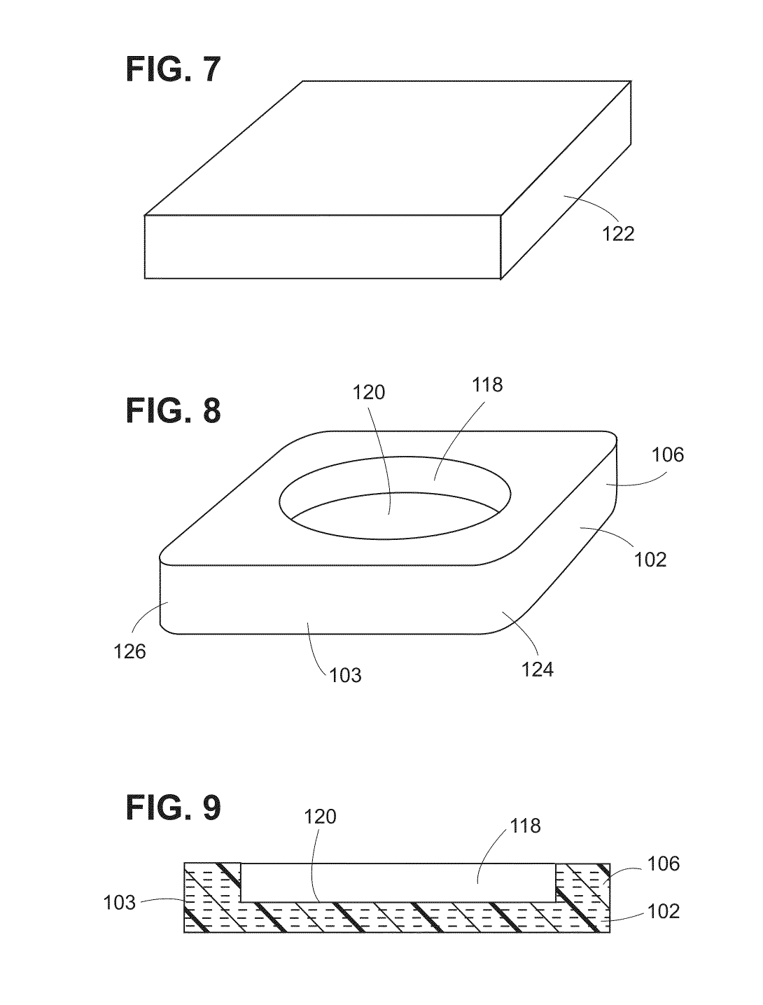

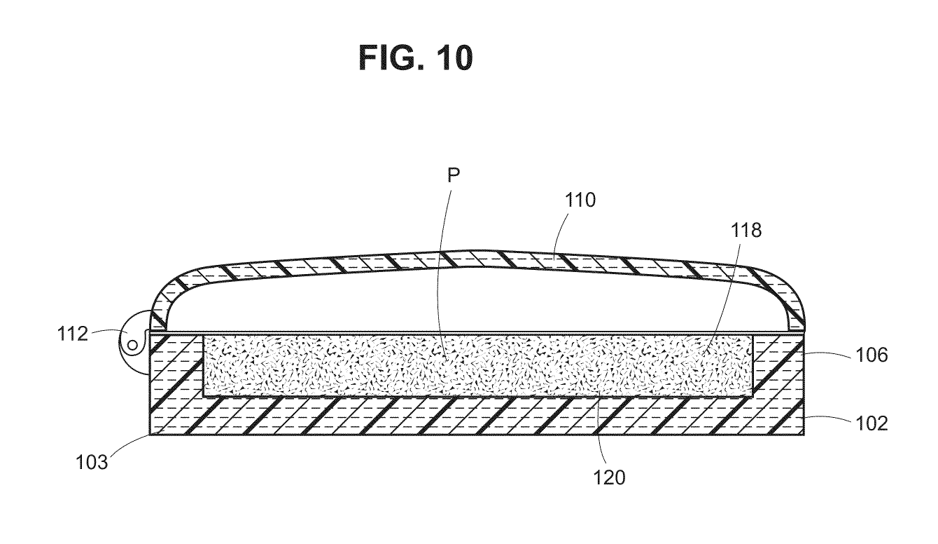

FIGS. 7-10 illustrate another embodiment of a biodegradable component 106 for a package 102 for storing and dispensing cosmetic and beauty care products. The component 106 has a solid body 103 made of compressed fibrous biomass and a cosmetically compatible and compostable binder. The body 103 has a reservoir 118 for storing and dispensing a cosmetic product P (see FIGS. 8 and 10). At least one surface 120 of the body, preferably in the reservoir 118 is adapted to contact the product and preferably have increased adhesion to the product P (see FIG. 10). A cover 110 is secured to the body 103 by, for example, a hinge 112. The cover 110 may be made from a conventional plastic, metal or resin, or alternatively, the cover 110 may be made from molded or machined biodegradable fibrous biomass in compostable binder similar to that of the body 103 or other components described herein. The component 106 can be made by molding a solid body 103 with a reservoir 118 by the methods of molding with a cavity and die described above, either in separate molding cycles for the component and product or in a single cycle as described herein. Alternatively, the component 106 is made from a solid piece of pre-manufactured fibrous biomass material in the form of a block or board 122 (see FIG. 7). The block or board is mechanically worked or machined to, for example round the corners (see ref numbers 124, 126 in FIG. 8), and to provide the reservoir 118, i.e., to achieve the desired shape and configuration of the component 106. The mechanical working or machining is in the form of boring, milling, cutting, laser cutting, stamping, die cutting or grinding the block or board 122 to round the corners (124, 126) and/or create the reservoir 118 in the body 103. The fibrous biomass of component 106 includes a cosmetically compatible and compostable binder. The cosmetically compatible and compostable binder may be in whole or part a resin selected from the group consisting of a biodegradable one of polyurethane resin, polyester, aliphatitic polyester, polyvinyl alcohol, polycaprolactone, polyhydroxyalkanoate, denatured starch, a natural polymer, a polyisocyanate, polyglycolic acid, polylactic acid, polyhydroxybutyric acid, polyhydroxyvaleric acid, a polyhydroxycarboxylic acids, polybutylene succinate and polybutylene adipatea, or any other suitable binder that is compostable and cosmetically compatible. Alternatively, the cosmetically compatible and compostable binder in the fibrous biomass in the component 106 may be in whole or part a naturally occurring constituent of the fibrous biomass. The board or block 122 can be made by molding, extrusion, casting or any other method suitable for manufacturing such block or board.

Advantages of component 106 are that the body 103 forms a near complete package 102 in a single, easily manufactured piece that avoids complex assembly or gluing. Where the first embodiment (FIG. 1) has a separate base 8 and pan 16 that must be secured together with adhesive 14, the embodiment in FIGS. 8 and 9 is a complete, 1 piece solid base for a compact with a cavity reservoir. It is therefore highly cost effective to produce. Furthermore, the solid body 103 provides a significant weight and heft to the package that gives it a substantial, quality feel and avoids the hollow sounds of a typical plastic compact. In addition, the significant weight and heft of the solid body 103 of the present embodiment allows manufacturers to avoid steps typically taken with hollow plastic compacts to increase the weight, heft and quality feel. For example, hollow plastic compacts often have steel plates added to increase the weight to provide the substantial, quality feel, or have hollow voids backfilled with foam to give the compact a more solid feel. The addition of steel or foam adds to the cost of manufacture in both materials and additional processing costs. The solid body 103 of the present embodiment avoids the added cost of steel or foam while still providing a quiet compact with a quality weight, heft and feel. All that is needed on the single piece body 103 to complete the cosmetic package is product P in the reservoir 118 (see FIG. 10) and a cover 110 secured, for example, by a hinge 112 that is glued, staked, pinned or otherwise fastened to the body 103 and cover 110. Exposed surfaces of the compact can be lacquered, painted, coated, sheathed, veneered, foiled, laminated or otherwise decorated by known and conventional techniques.

Another embodiment of the invention is a method for forming a cosmetic product insert 206 for a cosmetic compact 4. This is best illustrated in FIGS. 5 and 6. The insert 206 (FIG. 6) has a quantity of product P in the form of a dispensable product supply portion 208. The dispensable product supply portion 208 is secured to a support portion 210. The support portion 210 is comprised of fibrous biomass and a cosmetically compatible and compostable binder. The method comprises the steps of providing a mold cavity 26 defined by a bottom wall 24 and a side wall 22. A corresponding die 34 is provided. The cavity 26 and die 34 when fully closed are dimensioned to form the insert 206 in a preselected and desired shape. A quantity of cosmetic product 44 is provided in a form suitable for placing in the cavity 26. The quantity of cosmetic product is sufficient to form the dispensable supply portion 208 and contains a cosmetically compatible cosmetic product binder. A quantity of fibrous biomass sufficient to form the support portion 210 is provided. The fibrous biomass contains a cosmetically compatible and compostable binder in an uncured state. A first layer selected from one of the quantity of cosmetic product and the quantity of fibrous biomass is placed in the cavity. A second layer selected from the other of the quantity of cosmetic product and the quantity of fibrous biomass is placed in the cavity above the first layer. The die is closed onto the mold cavity under pressure to compress the second layer and the first layer, and to adhere the second layer to the first layer such that the insert 206 is formed. As noted above, the cosmetic product P includes a suitable cosmetically compatible cosmetic product binder and the quantity of fibrous biomass includes a cosmetically compatible and compostable biomass binder. The biomass binder and the cosmetic product binder may be the same binder, or the biomass binder and the cosmetic product binder may be different binders. The biomass binder may be in whole or part a resin selected from the group consisting of a biodegradable one of polyurethane resin, polyester, aliphatitic polyester, polyvinyl alcohol, polycaprolactone, polyhydroxyalkanoate, denatured starch, a natural polymer, a polyisocyanate, polyglycolic acid, polylactic acid, polyhydroxybutyric acid, polyhydroxyvaleric acid, a polyhydroxycarboxylic acids, polybutylene succinate and polybutylene adipatea, or any other suitable binder that is compostable and cosmetically compatible. Alternatively, the biomass binder may be in whole or part a naturally occurring component of the fibrous biomass. The first layer and second layer are compressed at a pressure in the range of 0.1 p.s.i to 2,500 p.s.i. The biomass fiber is selected from the at least one of wood pulp, cellulose, bamboo, willow, bagasse, corn, rice straw, reed, bulrush, coconut, agave, flax or palm. The form suitable for placing the quantity of cosmetic product in the cavity is selected from at least one of a liquid, a powder, a foam, a paste, a gel, a sheet, a plug, a mat, a block, a cake and a puck. The quantity of fibrous biomass may be provided to the method in a loose form. Alternatively, the quantity of fibrous biomass is provided wholly or partly pre-formed in the form of a sheet, a plug, a mat, a block, a cake, a fabric, a web or a puck.

The advantages of the present invention are numerous. The invention reduces the amount of non-biodegradable or non-compostable waste entering the waste stream. The invention allows manufacture in a variety of ways to create a package that has the weight and feel of a luxury goods package.

It is understood that various modifications and changes in the specific form and construction of the various parts can be made without departing from the scope of the following claims.

What is claimed is:

1. A method for forming a cosmetic product insert for a cosmetic compact, the insert having a quantity of cosmetic product in the form of a dispensable product supply portion, the dispensable product supply portion secured to a compostable support portion, the method comprising the steps of:
providing a mold cavity defined by a bottom wall and a side wall, and a corresponding die, the cavity and die when fully closed being dimensioned to form the insert in a preselected and desired shape;
providing the quantity of cosmetic product in a form suitable for placing in the cavity, the quantity of cosmetic product sufficient to form the dispensable product supply portion;
providing a quantity of fibrous biomass sufficient to form the support portion for the dispensable product supply portion;
placing in the cavity a first layer selected from one of the quantity of cosmetic product and the quantity of fibrous biomass;
placing in the cavity a second layer selected from the other of the quantity of cosmetic product and the quantity of fibrous biomass; and
closing the die onto the mold cavity and applying sufficient pressure to compress the second layer and the first layer, and to adhere the second layer to the first layer such that the insert is formed.

2. The method of claim 1 wherein the cosmetic product includes a suitable cosmetically compatible cosmetic product binder.

3. The method of claim 1 wherein the quantity of fibrous biomass further comprises a cosmetically compatible and compostable biomass binder.

4. The method of claim 3 wherein the cosmetic product includes a suitable cosmetically compatible cosmetic product binder.

5. The method of claim 4 wherein the biomass binder and the product binder are the same binder.

6. The method of claim 4 wherein the biomass binder and the product binder are different binders.

7. The method of claim 3 wherein the biomass binder is a resin selected from the group consisting of a biodegradable one of polyurethane resin, polyester, aliphatitic polyester, polyvinyl alcohol, polycaprolactone, polyhydroxyalkanoate, denatured starch, a natural polymer, a polyisocyanate, polyglycolic acid, polylactic acid, polyhydroxybutyric acid, polyhydroxyvaleric acid, a polyhydroxycarboxylic acids, polybutylene succinate and polybutylene adipatea.

8. The method of claim 4 wherein the biomass binder is a resin selected from the group consisting of a biodegradable one of polyurethane resin, polyester, aliphatitic polyester, polyvinyl alcohol, polycaprolactone, polyhydroxyalkanoate, denatured starch, a natural polymer, a polyisocyanate, polyglycolic acid, polylactic acid, polyhydroxybutyric acid, polyhydroxyvaleric acid, a polyhydroxycarboxylic acids, polybutylene succinate and polybutylene adipatea.

9. The method of claim 5 wherein the biomass binder is a resin selected from the group consisting of a biodegradable one of polyurethane resin, polyester, aliphatitic polyester, polyvinyl alcohol, polycaprolactone, polyhydroxyalkanoate, denatured starch, a natural polymer, a polyisocyanate, polyglycolic acid, polylactic acid, polyhydroxybutyric acid, polyhydroxyvaleric acid, a polyhydroxycarboxylic acids, polybutylene succinate and polybutylene adipatea.

10. The method of claim 1 wherein the first layer and second layer are compressed at a pressure in the range of 0.1 p.s.i to 2,500 p.s.i.

11. The method of claim 1 wherein the biomass fiber is selected from the at least one of wood pulp, cellulose, bamboo, willow, bagasse, corn, rice straw, reed, bulrush, coconut, agave, flax and palm.

12. The method of claim 1 wherein the form suitable for placing the quantity of cosmetic product in the cavity is selected from at least one of a powder, a particulate, a paste, a cake, a pomade, a pre-form, a liquid, a gel and a foam.

13. The method of claim 3 wherein the biomass binder is a naturally occurring component of the fibrous biomass.

14. The method of claim 4 wherein the biomass binder is a naturally occurring component of the fibrous biomass.

15. The method of claim 5 wherein the biomass binder is a naturally occurring component of the fibrous biomass.

16. The method of claim 1 wherein the quantity of fibrous biomass is provided in a loose form.

17. The method of claim 1 wherein the quantity of fibrous biomass is provided preformed in a form selected from at least one of a sheet, a plug, a mat, a block, a cake and a puck.

18. The method of claim 6 wherein the biomass binder is a naturally occurring component of the fibrous biomass.

19. The method of claim 1 wherein the form suitable for placing the quantity of cosmetic product in the cavity is selected from at least one of a liquid, a powder, a foam, a paste, a gel, a sheet, a plug, a mat, a block, a cake and a puck.

20. A cosmetic product insert for a cosmetic compact, the insert comprising:
a compostable support portion made from a compressed fibrous biomass bound by a cosmetically compatible and compostable binder, and a quantity of cosmetic product in the form of a dispensable product supply portion, the dispensable product supply portion secured to the compostable support portion.
